(19) United States
(12) Patent Application Publication
(10) Pub. No.: US 2011/0226416 A1
(43) Pub. Date: Sep. 22, 2011

(54) POLYMER FILM WITH MULTIPHASE FILM MORPHOLOGY

(75) Inventors: Matthias GERST, Maikammer (DE); Gerhard Auchter, Bad Duerkheim (DE); Rüdiger Stark, Viernheim (DE)

(73) Assignee: BASF SE, Ludwigshafen (DE)

(21) Appl. No.: 13/051,608

(22) Filed: Mar. 18, 2011

Related U.S. Application Data
(60) Provisional application No. 61/315,058, filed on Mar. 18, 2010.

(51) Int. Cl. C09J 5/02; C09J 167/00

(52) U.S. Cl. 156/308.6; 525/222

(57) ABSTRACT

Described is a polymer film with multiphase film morphology. The polymer film, within a layer, has regions of a first polymer and regions of a second polymer, and is prepared from an aqueous polymer dispersion, comprising the two polymers in dispersed form and a tackifier. The glass transition temperature of the second polymer is greater than that of the first polymer and less than 20° C. The concentration of the tackifier in the polymer film is greater in the regions of the first polymer than in the regions of the second polymer. Described also are polymer dispersions for producing polymer films with multiphase film morphology, and also applications as adhesive, coating or sealant, as for example for producing self-adhesive paper labels.

The invention relates to a polymer film with multiphase film morphology that within a layer has regions of a first polymer and regions of a second polymer and that is pre-pared from an aqueous polymer dispersion comprising the two polymers in dispersed form and a tackifier, the polymers being characterized by particular glass transition temperatures and also by a difference in solvency for the tackifier. The invention also relates to polymer dispersions for producing polymer films of the invention, and to applications as adhesive, coating or sealant.

With adhesives, coating compositions, and sealants, a frequent desire is for a combination of properties which are inversely proportional to one another. This means that an improvement in one desired property, such as increasing the quantity of an additive that is used, for example, can be acquired only at the expense of another desired performance property. Two important performance properties of pressure-sensitive adhesives are the peel strength (adhesion, attachment of the layer of adhesive to the substrate) and the shear strength (cohesion, internal strength of the layer of adhesive). Increasing the shear strength normally correlates with reducing the peel strength, and vice versa.

It was an object of the present invention to provide possibilities for improving one of the desired performance properties without adversely affecting the other desired property.

It has been found that this object can be achieved by means of polymer films having a multiphase film morphology, where controlled direction of the solubility of a specific additive in a particular polymer phase results in a controlled improvement in a desired performance property without detriment to other performance properties.

The invention provides a polymer film with multiphase morphology, where the film within a layer has regions of a first polymer and regions of at least one second polymer; the film is prepared from an aqueous polymer dispersion comprising the first polymer in dispersed form, at least one second polymer in dispersed form, and at least one tackifier;

the glass transition temperature of the second polymer is greater than the glass transition temperature of the first polymer and is less than 20° C.; and
the concentration of the tackifier in the polymer film in the regions of the first polymer is greater than in the regions of the second polymer.

A polymer film with multiphase film morphology is a film which is formed from at least two different polymers and in which the polymers in a single layer are present in different, spatially separate regions (also called phases below). The regions may be isolated regions or regions that form cocontinuous networks. In the case of isolated regions, one phase may be continuous and the other may be present a discontinuous phase within the continuous phase. Preference is given to cocontinuous phases, i.e. the film has regions of a first polymer that form cocontinuous networks, and also regions of at least one second polymer that form cocontinuous networks.

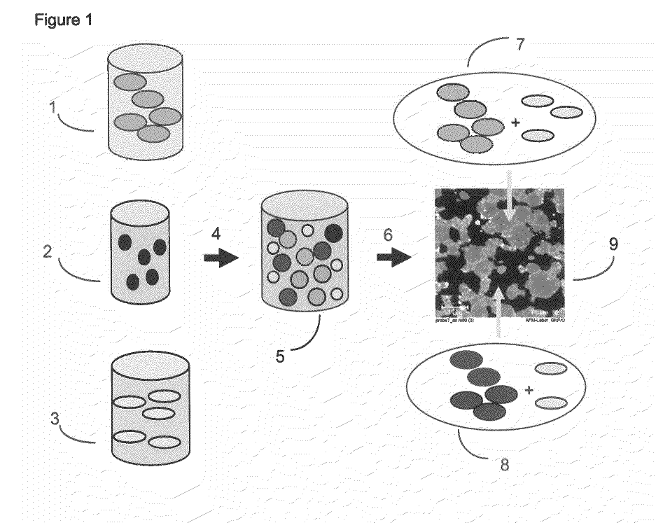

FIG. 1 shows a schematic representation of the formation of a multiphase polymer film with differences in the distribution of a tackifier within the various phases. An aqueous dispersion with 5 parts of a first polymer (1), an aqueous dispersion with 5 parts of a second polymer (2), and an aqueous dispersion with 5 parts of tackifier resin (3) are mixed (4). A mixed dispersion (5) is formed. The mixed dispersion (5) is dried and filmed (6) to produce a polymer film (9). The polymer film (9) is multiphase and has continuous regions of the first polymer (7) and continuous regions of the second polymer (8). In the regions of the first polymer (7) the fraction of dissolved tackifier (e.g., 3 parts) is higher than in the regions of the second polymer (8).

The relationship between the glass transition temperatures of the polymers used in the polymer mixture and the solubility of the tackifiers in the film polymers is set in accordance with the invention such that more tackifier is located in the “softer” polymer (first polymer with lower glass transition temperature) and less tackifier is located in the “harder” polymer (second polymer with higher glass transition temperature).

It has been found that the solubility of tackifiers in a polymer film can be adjusted purposely, by means of different alternative or cumulative measures, in such a way as to achieve the desired distribution of the tackifier in the various phases of a multiphase polymer film. It has emerged that the maximum tackifier solubility is a sign of the distribution of the tackifier in the various phases of a multiphase polymer film. More tackifier is located in the phase of that polymer which possesses the greater maximum tackifier solubility, even when less than the maximum soluble amount of tackifiers is used in a multiphase polymer. The maximum solubility of the tackifier in the phase of the first polymer is preferably at least 20%, more particularly at least 40%, greater than the maximum solubility of the tackifier in the phase of the second polymer.

Where the maximum tackifier solubility for the individual polymers is known or has been measured, it may if necessary be shifted in the desired direction by increase or reduction. An increase in the tackifier solubility can be produced, for example, by lowering the degree of crosslinking; or by varying the principal monomers; or by varying the amount of hydrophilic comonomers. A reduction in the tackifier solubility can be accomplished, for example, by raising the degree of crosslinking; or by appropriately varying the principal monomers; or by appropriately varying hydrophilic comonomers. For example, the switch of the principal monomer from n-butyl acrylate to ethylhexyl acrylate results in an increased tackifier solubility. Examples of hydrophilic comonomers which are able to alter the tackifier solubility include vinyl acetate, methyl acrylate or methyl methacrylate.

It is particularly advantageous to use the degree of crosslinking in order to adjust the tackifier solubility. Increasing the degree of crosslinking results in a reduced tackifier solubility, that has little or no effect on the glass transition temperature. One embodiment of the invention relates accordingly to a polymer film wherein the second polymer has a higher degree of crosslinking than the first polymer, and/or the monomer mixture from which the second polymer is formed comprises a higher fraction of polyunsaturated crosslinking monomers than the monomer mixture from which the first polymer is formed.

Crosslinking may take place through copolymerization of crosslinking monomers. Crosslinking monomers are, for example, monomers having at least two nonconjugated, polymerizable vinyl groups. These monomers may be used, for example, to an extent of at least 0.01% by weight, preferably from 0.01% to 0.5% by weight or from 0.05% to 0.1% by weight, the precise amount being set such that the desired tackifier solubility is achieved. Preferred vinyl groups of the crosslinking monomers are acrylic and methacrylic groups. Examples that may be mentioned include divinylbenzene, alkanediol diacrylates, alkanediol dimethacrylates, allyl acrylates and allyl methacrylates. Particularly preferred are alkanediol diacrylates and alkanediol dimethacrylates having in each case 2 to 8, preferably 4 to 6, C atoms in the alkanediol group. Especially preferred are allyl methacrylate, butanediol diacrylate, butanediol dimethacrylate, hexanediol diacrylate and hexanediol dimethacrylate, or a mixture thereof. Conversely, the crosslinking can be reduced and hence the tackifier solubility increased through the use of molecular weight regulators, examples being thiol compounds, of the type described in more detail below.

Reducing the tackifier solubility can also be accomplished by postcrosslinking, where the primary reaction product formed is subjected to an aftertreatment after the polymerization proper, and is reacted with initiators that form free nonionic radicals. Examples of initiators suitable for this purpose are compounds that form free hydroxyl radicals, such as hydrogen peroxide or organic hydroperoxides, for example, or compounds that form free alkoxy radicals, such as organic alkyl peroxides, for example. Examples of initiators for the aftertreatment are hydrogen peroxide, dibenzoyl peroxide, tert-butyl perpivalate, tert-butyl per-2-ethylhexanoate, di-tert-butyl peroxide, diamyl peroxide, dioctanoyl peroxide, didecanoyl peroxide, dilauroyl peroxide, bis(o-tolyl) peroxide, succinyl peroxide, tert-butyl peracetate, tert-butyl permaleate, tert-butyl perisobutyrate, tert-butyl perpivalate, tert-butyl peroctoate, tert-butyl perbenzoate, tert-butyl hydroperoxide. It is preferred to use peroxide compounds selected from hydrogen peroxide, organic peroxides, and organic hydroperoxides. It is particularly preferred to carry out aftertreatment using a redox initiator system, the oxidizing component used being at least one peroxide compound selected from hydrogen peroxide, organic peroxides, and organic hydroperoxides, and the reducing component used being an organic or inorganic reducing agent. The reducing components are, for example, alkali metal salts of sulfurous acid, such as sodium sulfite, sodium hydrogen sulfite, alkali metal salts of disulfurous acid such as sodium disulfite, bisulfite addition compounds with aliphatic aldehydes and ketones, such as acetone bisulfite, or reducing agents such as hydroxymethanesulfinic acid and salts thereof, or ascorbic acid. The redox initiator systems for the aftertreatment may be used together with soluble metal compounds whose metallic component is able to exist in a plurality of valence states. Redox initiator systems are, for example, ascorbic acid/iron(II) sulfate/sodium peroxydisulfate, tert-butyl hydroperoxide/sodium disulfite, tert-butyl hydroperoxide/Na hydroxymethane sulfinate or tert-butyl hydroperoxide/ascorbic acid. The individual components, the reducing component, for example, may also be mixtures, an example being a mixture of the sodium salt of hydroxymethanesulfinic acid with sodium disulfite. Particularly preferred for the aftertreatment are hydrogen peroxide/ascorbic acid, tert-butyl hydroperoxide/ascorbic acid, and tert-butyl hydroperoxide/acetone bisulfite. The amounts of initiator used for the aftertreatment are preferably from 0.001 to 0.1 part by weight, more preferably from 0.002 to 0.05 part by weight, based on 100 parts by weight of monomers. The initiators for the aftertreatment are added after the main polymerization of the monomers has taken place, i.e., after preferably more than 50%, in particular at least 70% or at least 90%, or more preferably 100%, by weight of all the monomers have been added and preferably more than 50%, in particular at least 70% or at least 90%, by weight of all the monomers have undergone polymerization.

Based on the total amount of the film, the first polymer is present preferably in an amount of 10 to 60 parts by weight, more preferably of 20 to 50 parts by weight. Based on the total amount of the film, the second polymer is present preferably in an amount of 10 to 60 parts by weight, more preferably of 20 to 50 parts by weight. Based on the total amount of the film, the tackifier is present preferably in an amount of 10 to 40 parts by weight, more preferably of 20 to 30 parts by weight.

The glass transition temperature of the polymers can be determined by means of differential scanning calorimetry (ASTM D 3418-08, midpoint temperature). The glass transition temperature of the first polymer is preferably less than 0° C., more preferably −60 to less than or equal to −10° C., or −60 to less than or equal to −20° C., or −60° C. to less than or equal to −20° C., more preferably −60 to less than or equal to −30° C.

The glass transition temperature of the second polymer is less than 20° C. and is preferably −50 to less than or equal to 10° C., preferably −50 to less than or equal to 0° C. or −50 to less than or equal to −10° C., more preferably −50 to less than or equal to −20° C. The glass transition temperature of the second polymer is preferably greater by at least 2° C., more preferably by at least 4° C., than the glass transition temperature of the first polymer.

In the text below, the designation (meth)acrylate and similar designations are used as an abbreviating notation for “acrylate or methacrylate”.

The polymers for use are preferably polymers which are obtainable by free-radical polymerization of ethylenically unsaturated compounds (monomers). The polymer is composed preferably to an extent of at least 40% or at least 60%, or at least 80%, more preferably at least 90%, by weight of what are called principal monomers. The principal monomers are preferably selected from C1 to C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers.

Examples of suitable monomers are (meth)acrylic acid alkyl esters with a C₁-C₁₀ alkyl radical, such as methyl methacrylate, methyl acrylate, n-butyl acrylate, ethyl acrylate, and 2-ethylhexyl acrylate. Also suitable in particular are mixtures of the (meth)acrylic acid alkyl esters. Vinyl esters of carboxylic acids having 1 to 20 C atoms are, for example, vinyl laurate, vinyl stearate, vinyl propionate, Versatic acid vinyl esters, and vinyl acetate. Suitable vinylaromatic compounds include vinyltoluene, a- and p-methylstyrene, a-butylstyrene, 4-n-butylstyrene, 4-n-decylstyrene, and—preferably—styrene. Examples of nitriles are acrylonitrile and methacrylonitrile. The vinyl halides are ethylenically unsaturated compounds substituted by chlorine, fluorine or bromine, preferably vinyl chloride and vinylidene chloride. Examples of vinyl ethers include vinyl methyl ether or vinyl isobutyl ether. Preference is given to vinyl ethers of alcohols comprising 1 to 4 C atoms. Suitable hydrocarbons having 4 to 8 C atoms and two olefinic double bonds are, for example, butadiene, isoprene, and chloroprene.

Preferred principal monomers are C₁ to C₁₀ alkyl acrylates and C₁ to C₁₀ alkyl methacrylates, more particularly C₁ to C₈ alkyl acrylates and methacrylates, and vinylaromatics, more particularly styrene, and mixtures thereof. Especially preferred are methyl acrylate, methyl methacrylate, ethyl acrylate, n-butyl acrylate, n-hexyl acrylate, octyl acrylate, and 2-ethylhexyl acrylate, styrene, and mixtures of these monomers. More particularly the polymers are composed of at least 60%, more preferably at least 80%, and very preferably at least 90% or at least 95%, by weight of C₁ to C₁₀ alkyl (meth)acrylates.

The polymer is composed to an extent preferably of at least 50%, more preferably at least 55%, very preferably 55% to 90%, by weight of at least one soft acrylate monomer selected from alkyl acrylates which when polymerized as a homopolymer have a glass transition temperature of less than 0° C., preferably less than −10° C. or less than −20° C., more preferably less than −30° C. Soft acrylate monomers are, for example, acrylic acid alkyl esters with a C₂-C₁₀ alkyl radical. Examples include ethyl acrylate, n-propyl acrylate, isobutyl acrylate, sec-butyl acrylate, tert-butyl acrylate, n-butyl acrylate, n-hexyl acrylate, and 2-ethylhexyl acrylate. Particularly preferred are n-butyl acrylate and 2-ethylhexyl acrylate and a mixture thereof.

Besides the soft acrylate monomers, the polymers may also comprise what are called hard acrylate monomers, in amounts of 1% to 30% by weight, for example, provided that the inventive conditions concerning the glass transition temperatures are met. Hard acrylate monomers are, for example, alkyl acrylates and alkyl methacrylates having in each case 1 to 10 C atoms in the alkyl group, provided that the glass transition temperature of the respective homopolymer is at least 60° C., more preferably at least 80° C. Preferred alkyl methacrylates are those having 1 to 4 C atoms in the alkyl group. Examples of hard acrylate monomers include methyl methacrylate, ethyl methacrylate, isobutyl methacrylate, and tert-butyl methacrylate. Particularly preferred is methyl methacrylate.

Besides the principal monomers, the polymer may comprise further monomers, examples being ethylenically unsaturated monomers having carboxylic, sulfonic or phosphonic acid groups (acid monomers). Carboxylic acid groups are preferred. One embodiment uses acid monomers at not less than 0.1%, preferably from 0.1% to 10%, or from 0.5% to 8%, or from 1% to 6%, by weight, based on the polymer. Examples of acid monomers include ethylenically unsaturated carboxylic acids, ethylenically unsaturated sulfonic acids, and vinylphosphonic acid. As ethylenically unsaturated carboxylic acids it is preferred to use alpha,beta-monoethylenically unsaturated monocarboxylic and dicarboxylic acids having 3 to 6 C atoms in the molecule. Examples of such are acrylic acid, methacrylic acid, itaconic acid, maleic acid, fumaric acid, crotonic acid, vinylacetic acid, and vinyllactic acid. Examples of suitable ethylenically unsaturated sulfonic acids include vinylsulfonic acid, styrenesulfonic acid, acrylamidomethylpropanesulfonic acid, sulfopropyl acrylate, and sulfopropyl methacrylate. Preferred are acrylic acid and methacrylic acid and a mixture thereof; particularly preferred is acrylic acid. The monomers comprising acid groups can be used in the polymerization in the form of the free acids and also in a form partly or wholly neutralized with suitable bases. Neutralizing agents used with preference include sodium hydroxide solution, potassium hydroxide solution, and ammonia.

Further monomers are also, for example, monomers comprising hydroxyl groups, more particularly C₁-C₁₀ hydroxyalkyl (meth)acrylates, or (meth)acrylamide. Further monomers additionally include phenyloxyethylglycol mono(meth)acrylate, glycidyl (meth)acrylate, and aminoalkyl (meth)acrylates such as 2-aminoethyl (meth)acrylate, for example. Alkyl groups have preferably from 1 to 20 C atoms.

In one preferred embodiment of the invention the first polymer and the second polymer are composed of
(a) at least 60% by weight of at least one acrylate monomer selected from C1 to C10 alkyl acrylates which when polymerized as a homopolymer have a glass transition temperature of less than 0° C.,
(b) at least 0.1% by weight of at least one ethylenically unsaturated acid monomer, and
(c) optionally, further monomers different from monomers (a)-(b), the nature and amount of the monomers being adjusted such that the glass transition temperature of the second polymer is at least 2° C. greater than the glass transition temperature of the first polymer.

In one preferred embodiment of the invention the first polymer is composed of
(a) 60% to 90% by weight of 2-ethylhexyl acrylate,
(b) 0.1% to 5% by weight of acid monomers selected from acrylic acid, methacrylic acid, and a mixture thereof, and
(c) 5% to 29.9% by weight of further monomers different from monomers (a)-(b); and the second polymer is composed of
(a) 60 to 90% by weight of n-butyl acrylate,
(b) 0.1 to 5% by weight of acid monomers selected from acrylic acid, methacrylic acid and a mixture thereof, and
(c) 5 to 29.9% by weight of further monomers different from monomers (a)-(b).

A preferred polymer film comprises

(A) 20% to 60% by weight of the first polymer, formed from
(a) 60% to 90% by weight of 2-ethylhexyl acrylate,
(b) 0.1% to 5% by weight of acid monomers selected from acrylic acid, methacrylic acid and a mixture thereof, and
(c) 5 to 29.9% by weight of further monomers different from monomers (a)-(b);
   (B) 20% to 60% by weight of the second polymer, formed from
(a) 60% to 90% by weight of n-butyl acrylate,
(b) 0.1% to 5% by weight of acid monomers selected from acrylic acid, methacrylic acid and a mixture thereof, and
(c) 5 to 29.9% by weight of acid monomers different from monomers (a)-(b); and
   (C) 15% to 50% by weight of tackifiers based on natural resins.

In one preferred embodiment the polymers are prepared by emulsion polymerization, and the product is therefore an emulsion polymer. The emulsion polymerization is carried out using ionic and/or nonionic emulsifiers and/or protective colloids, or stabilizers, as surface-active compounds. A comprehensive description of suitable protective colloids is found in Houben-Weyl, Methoden der organischen Chemie, volume XIV/1, Makromolekulare Stoffe [Macromolecular Compounds], Georg Thieme Verlag, Stuttgart, 1961, pp. 411 to 420. Emulsifiers contemplated include anionic, cationic, and nonionic emulsifiers. As accompanying surface-active substances it is preferred to use exclusively emulsifiers, whose molecular weights, unlike those of the protective colloids, are usually below 2000 g/mol. Where mixtures of surface-active substances are used, the individual components must of course be compatible with one another, something which in case of doubt can be checked by means of a few preliminary tests. It is preferred to use anionic and nonionic emulsifiers as surface-active substances. Common accompanying emulsifiers are, for example, ethoxylated fatty alcohols (EO degree: 3 to 50, alkyl radical: C₆ to C₃₆), ethoxylated mono-, di-, and tri-alkylphenols (EO degree: 3 to 50, alkyl radical: C₄ to C₉), alkali metal salts of dialkyl esters of sulfosuccinic acid, and alkali metal salts and ammonium salts of alkyl sulfates (alkyl radical: C₈ to C₁₂), of ethoxylated alkanols (EO degree: 4 to 30, alkyl radical: C₁₂ to C₁₈), of ethoxylated alkylphenols (EO degree: 3 to 50, alkyl radical: C₄ to C₉), of alkylsulfonic acids (alkyl radical: C₁₂ to C₁₈), and of alkylarylsulfonic acids (alkyl radical: C₉ to C₁₈).

Other suitable emulsifiers are compounds of the general formula I

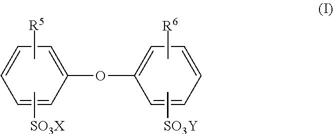

in which R⁵ and R⁶ are hydrogen or C₄ to C₁₄ alkyl and are not simultaneously hydrogen, and X and Y may be alkali metal ions and/or ammonium ions. Preferably, R⁵ and R⁶ are linear or branched alkyl radicals having 6 to 18 C atoms or hydrogen, and more particularly having 6, 12, and 16 C atoms, and R⁵ and R⁶ are not both simultaneously hydrogen. X and Y are preferably sodium, potassium or ammonium ions, with sodium being particularly preferred. Particularly advantageous compounds I are those in which X and Y are sodium, R⁵ is a branched alkyl radical having 12 C atoms, and R⁶ is hydrogen or R⁵. Use is frequently made of technical mixtures which contain a fraction of 50% to 90% by weight of the monoalkylated product, an example being Dowfax®2A1 (trademark of the Dow Chemical Company).

Suitable emulsifiers are also found in Houben-Weyl, Methoden der organischen Chemie, volume 14/1, Makromolekulare Stoffe, Georg Thieme Verlag, Stuttgart, 1961, pages 192 to 208. Examples of emulsifier tradenames include Dowfax® 2 A1, Emulan® NP 50, Dextrol® OC 50, Emulgator 825, Emulgator 825 S, Emulan®OG, Texapon® NSO, Nekanil® 904 S, Lumiten® I-RA, Lumiten® E 3065, Disponil® FES 77, Lutensol® AT 18, Steinapol® VSL, and Emulphor® NPS 25. For the present invention, ionic emulsifiers or protective colloids are preferred. Particular preference is given to ionic emulsifiers, more particularly salts and acids, such as carboxylic acids, sulfonic acids, and sulfates, sulfonates or carboxylates. The surface-active substance is used typically in amounts from 0.1 to 10 parts by weight, preferably 0.2 to 5 parts by weight, based on 100 parts by weight of the monomers to be polymerized.

Water-soluble initiators for the emulsion polymerization are, for example, ammonium salts and alkali metal salts of peroxydisulfuric acid, e.g., sodium peroxodisulfate, hydrogen peroxide or organic peroxide, e.g., tert-butyl hydroperoxide. Also suitable are what are called reduction-oxidation (redox) initiator systems. The redox initiator systems are composed of at least one, usually inorganic, reducing agent and one organic or inorganic oxidizing agent. The oxidizing component comprises, for example, the aforementioned initiators for the emulsion polymerization. The reducing component comprises, for example, alkali metal salts of sulfurous acid, such as sodium sulfite, sodium hydrogen sulfite, alkali metal salts of disulfurous acid such as sodium disulfite, bisulfite addition compounds of aliphatic aldehydes and ketones, such as acetone bisulfite, or reducing agents such as hydroxymethanesulfinic acid and salts thereof, or ascorbic acid. The redox initiator systems can be used together with soluble metal compounds whose metallic component is able to exist in a plurality of valence states. Examples of typical redox initiator systems include ascorbic acid/iron(II) sulfate/sodium peroxydisulfate, tert-butyl hydroperoxide/sodium disulfite, tert-butyl hydroperoxide/Na hydroxymethanesulfinate acid. The individual components, the reducing component, for example, may also be mixtures: for example, a mixture of sodium salt of hydroxymethanesulfinic acid and sodium disulfite. The stated compounds are used usually in the form of aqueous solutions, the lower concentration being determined by the amount of water that is acceptable in the dispersion, and the upper concentration by the solubility of the respective compound in water. Generally speaking, the concentration is 0.1% to 30%, preferably 0.5% to 20%, more preferably 1.0% to 10%, by weight, based on the solution.

The amount of the initiators is generally 0.1% to 10%, preferably 0.5% to 5%, by weight, based on the monomers to be polymerized. It is also possible for two or more different initiators to be used in the emulsion polymerization.

In the polymerization it is possible to use molecular weight regulators, in amounts, for example, of 0 to 0.8 part by weight, based on 100 parts by weight of the monomers to be polymerized, these regulators having the effect of reducing the molar mass. Examples of suitable compounds are those having a thiol group such as tert-butyl mercaptan, thioglycolic esters, such as 2-ethylhexyl thioglycolate, mercaptoethynol, mercaptopropyltrimethoxysilane, n-dodecyl mercaptan or tert-dodecyl mercaptan. Other suitable regulators include C6 to C20 hydrocarbons which on abstraction of hydrogen form a pentadienyl radical, e.g., terpinolene.

The emulsion polymerization takes place in general at 30° C. to 130° C., preferably 50° C. to 90° C. The polymerization medium may be composed either of water alone or of mixtures of water and water-miscible liquids such as methanol. It is preferred to use just water. The emulsion polymerization may be carried out either as a batch operation or in the form of a feed process, including staged or gradient procedures. Preference is given to the feed process, in which a portion of the polymerization batch is introduced as the initial charge, heated to the polymerization temperature, and partly polymerized, and then the remainder of the polymerization batch, typically via two or more spatially separate feed streams, of which one or more comprise the monomers in pure form or in emulsified form, is supplied to the polymerization zone, continuously, in stages or subject to a concentration gradient, during which the polymerization is maintained. In the polymerization it is also possible to include a polymer seed in the initial charge for the purpose, for example, of setting the particle size more effectively.

The manner in which the initiator is added to the polymerization vessel in the course of the free-radical aqueous emulsion polymerization is known to a person with ordinary skill in the art. The initiator may either be included in its entirety in the initial charge to the polymerization vessel, or else used in proportion with the rate at which it is consumed in the course of the free-radical aqueous emulsion polymerization, continuously or in stages. In each specific case this will be dependent both on the chemical nature of the initiator system and on the polymerization temperature. It is preferred to include a portion in the initial charge and to add the remainder to the polymerization zone in proportion with the rate of its consumption. For the purpose of removing the residual monomers it is also common, after the end of the emulsion polymerization proper, i.e., after a monomer conversion of at least 95%, to add initiator. The individual components can be added to the reactor, in the case of the feed process, from above, at the side, or from below, through the reactor base.

The emulsion polymerization produces aqueous dispersions of the polymer with solids contents in general of 15% to 75%, preferably of 40% to 75%, by weight. For a high space/time yield of the reactor, dispersions having a very solids content are preferred. In order to be able to achieve solids contents >60% by weight, a bimodal or polymodal particle size ought to be established, since otherwise the viscosity becomes too high and the dispersion can no longer be managed. Producing a new generation of particles can be accomplished, for example, by adding seed (EP 81083), by adding excess amounts of emulsifier or by adding miniemulsions. A further advantage associated with the combination of low viscosity and high solids content is the improved coating behavior at high solids contents. Producing one or more new generations of particles can be done at any desired point in time. This point in time is guided by the target particle size distribution for a low viscosity.

The invention further provides aqueous polymer dispersions for forming the polymer films of the invention with multiphase film morphology, comprising a first polymer in dispersed form, as described above, at least one different, second polymer in dispersed form, as described above, and at least one tackifier in dispersion or solution in the polymer dispersion, the glass transition temperature of the second polymer being greater than the glass transition temperature of the first polymer and being less than 20° C., and the maximum solubility of the tackifier in the first polymer being greater than the maximum solubility of the tackifier in the second polymer.

The polymer thus prepared is used preferably in the form of its aqueous dispersion for producing the polymer film. The size distribution of the dispersion particles may be monomodal, bimodal or multimodal. In the case of a monomodal particle size distribution, the average size of the polymer particles dispersed in the aqueous dispersion is preferably less than 400 nm, more particularly less than 200 nm. With particular preference the average particle size is between 140 and 200 nm. By average particle size here is meant the d₅₀ value of the particle size distribution, i.e., 50% by weight of the total mass of all particles have a particle diameter smaller than the d₅₀ value. The particle size distribution can be determined in a known way using the analytical ultracentrifuge (W. Mächtle, Makromolekulare Chemie 185 (1984), pages 1025-1039). In the case of bimodal or multimodal particle size distribution, the particle size may be up to 1000 nm. The pH of the polymer dispersion is preferably established at a pH of more than 4.5, more particularly at a pH of between 5 and 8.

In accordance with the invention at least one tackifier is used. Tackifiers are know per se to the skilled worker. They are adjuvants for adhesives or elastomers that increase the autoadhesion (tack, inherent tackiness, self-adhesion) of such systems. They generally have a relatively low molar mass (Mn approximately 200-2000 g/mol), a glass transition temperature which lies above that of the elastomers, and a sufficient compatibility with said elastomers—that is, the tackifiers dissolve at least partly in polymer films formed from the elastomers.

The amount by weight of the tackifiers is preferably 5 to 100 parts by weight, more preferably 10 to 50 parts by weight, based on 100 parts by weight of polymer (solids/solids).

The weight fraction of the tackifier in the multiphase polymer film of the invention is preferably at least 20%, more preferably at least 40%, greater in the regions (the phase) of the first polymer than in the regions (the phase) of the second polymer.

Examples of suitable tackifiers include those based on natural resins, such as rosins, for example. Tackifiers based on natural resins comprise the natural resins themselves and also their derivatives formed, for example, by disproportionation or isomerization, polymerization, dimerization or hydrogenation. These derivatives may be present in their salt form (with, for example, monovalent or polyvalent counterions (cations)) or preferably in their esterified form. Alcohols used for the esterification may be monohydric or polyhydric. Examples are methanol, ethanediol, diethylene glycol, triethylene glycol, 1,2,3-propanetriol, and pentaerythritol. Also used as tackifiers are phenolic resins, hydrocarbon resins, e.g., coumarone-indene resins, polyterpene resins, terpene oligomers, hydrocarbon resins based on unsaturated CH compounds, such as butadiene, pentene, methylbutene, isoprene, piperylene, divinylmethane, pentadiene, cyclopentene, cyclopentadiene, cyclohexadiene, styrene, a-methylstyrene, and vinyltoluene. Tackifiers used increasingly also include polyacrylates which have a low molar weight. These polyacrylates preferably have a weight-average molecular weight M_{w} of below 30 000. The polyacrylates are composed preferably to an extent of at least 60%, more particularly at least 80%, by weight of C₁-C₈ alkyl (meth)acrylates. Preferred tackifiers are natural or chemically modified rosins. Rosins are composed predominantly of abietic acid or derivatives of abietic acid.

The amount of tackifier dissolved in different phases of a multiphase polymer film can be measured by the method described in the examples. By AFM measurement (Atomic Force Microscope) in the HarmoniX™ measurement mode it is possible to measure the elasticity modulus, as a measure of the hardness of a polymer film. With a pure polymer and increasing amounts of tackifier it is possible to produce a correlation between elasticity modulus and tackifier content. As the tackifier content goes up, the elasticity modulus increases until the maximum solubility of the tackifier in the polymer film is reached, at which point the modulus reaches a plateau value. In this way it is possible to produce a calibration curve and to determine the maximum tackifier solubility in the polymer film. By measuring the different moduli of elasticity in the different regions of a multiphase polymer film, and comparing the results with the calibration curves produced beforehand, it is possible to ascertain the tackifier content in each individual region or in each phase of the multiphase polymer film.

The present invention additionally provides a process for producing a polymer film with multiphase film morphology, wherein
(1) a first polymer and at least one second polymer are provided and the polymers, after filming of a mixture of the polymers, form a film having different regions within a layer, the glass transition temperature of the second polymer being greater than the glass transition temperature of the first polymer and being less than 20° C.;
(2) at least one tackifier is provided which is soluble both in the regions of the first polymer and in the regions of the second polymer; the maximum solubility of the tackifier in the regions of the first polymer is greater than the maximum solubility of the tackifier in the regions of the second polymer;
(3) from the first polymer, the second polymer, and the tackifier an aqueous dispersion is prepared;
(4) the dispersion is applied to a substrate; and
(5) a film is formed by evaporation of the water.

The process of the invention is preferably a process for adhesively bonding two substrates, in which the first substrate, following the application of the aqueous dispersion, is contacted with a second substrate and an adhesive bond is produced between the two substrates.

The polymer films and polymer dispersions of the invention may be used as adhesive, coating or sealant. Preference is given to adhesive applications, more particularly in the form of a pressure-sensitive adhesive. Adhesive, coating or sealant compositions may be composed solely of an aqueous dispersion of the invention. They may also, however, comprise further additives, such as fillers, dyes, flow control agents or thickeners, for example.

The polymer films and polymer dispersions of the invention are suitable more particularly as pressure-sensitive adhesives for producing self-adhesive articles, such as labels, adhesive tapes or adhesive sheets, examples being protective sheets. The self-adhesive articles are composed in general of a carrier and a layer of the adhesive applied on one or both sides, preferably one side. The carrier material may comprise, for example, paper or polymeric films, composed of polyolefins or PVC, for example. Particular preference is given to an application for the production of self-adhesive paper labels, self-adhesive film labels or adhesive tapes.

To produce the layer of adhesive on the carrier material it is possible for the carrier material to be coated conventionally. The coated substrates obtained are used, for example, as self-adhesive articles, such as labels, adhesive tapes or films.

The polymer films and polymer dispersions of the invention have good performance properties, more particularly good peel strength (adhesion) and good shear strength (cohesion), the adhesion and cohesion values for the inventive mixture of tackifier and (at least) two polymers going beyond the values for compositions composed of tackifier and just one polymer.

### EXAMPLES

### Ingredient:

EHA 2-ethylhexyl acrylate
BA n-butyl acrylate
VAc vinyl acetate
MMA methyl methacrylate
EA ethyl acrylate
S styrene
HPA hydroxypropyl acrylate
AA acrylic acid
NaPS sodium persulfate
Dermulsene® DP 604 aqueous tackifier dispersion, 53% content, based on rosin ester/hydrocarbon hybrid resin
Snowtack® 932 rosin-based tackifier
Arizona® XR 4338 rosin-based tackifier
Euro Yser® rosin-based tackifier

Two polymer dispersions, A and B, were prepared by emulsion polymerization from the constituents listed in table 1.

TABLE 1
Polymer dispersions A and B; amounts in parts by weight

| | Dispersion A | Dispersion B |
|---|---|---|
| EHA | 79.5 | 10 |
| BA | 0 | 75.25 |
| VAc | 8 | 5 |
| MMA | 8 | 0 |
| EA | 0 | 5 |
| S | 2 | 2 |
| HPA | 2 | 2 |
| AA | 0.5 | 0.75 |
| NaPS | 0.5 | 0.5 |

Aqueous polymer dispersions were obtained which have the properties listed in table 2.

TABLE 2
Properties of dispersions A and B

| | Dispersion A | Dispersion B |
|---|---|---|
| Tg [° C.] ¹⁾ | −42 | −36 |
| Gel content | 20% by weight | 30% by weight |
| Maximum tackifier | >35% by weight | <30% by weight |
| solubility ²⁾ | | |

¹⁾ Glass transition temperature
²⁾ Maximum solubility of Dermulsene ® DP 604 in the polymer film

### Measurement of Maximum Tackifier Solubility

The maximum solubility of a tackifier in a polymer film is measured by characterizing two or more films produced from mixtures of an individual polymer dispersion with increasing tackifier fraction by means of AFM measurement (Atomic Force Microscope). This is done by imaging a section of a dispersion film in the HarmoniX™ mode and determining the elasticity modulus. If the tackifier is no longer soluble in the polymer, hard agglomerates of the tackifier form in the interstitial phase, and there is no further increase in the elasticity modulus of the particles. Both can be detected qualitatively and quantitatively on the basis of a HarmoniX™ AFM image. The measurement can be carried out using the Dimension V instrument from Veeco, with a soft HarmoniX™ unsupported arm (approximately 40 MPa-700 MPa).

### Measurement of Tackifier Distribution in the Polymer Film

The tackifier distribution in a multiphase polymer film formed from a mixture of two or more polymer dispersions is measured by imaging a section of the polymer film in HarmoniX™ mode and determining the elasticity modulus. The difference in distribution can be measured as a result of different elasticity moduli for the individual phases of the polymer film. In order to determine the quantitative distribution, comparative measurements are employed on the pure dispersions with different proportions of tackifier. With a pure polymer and increasing amounts of tackifier, a correlation can be produced between elasticity modulus and tackifier content. As the tackifier content goes up, the elasticity modulus increases until the maximum solubility of the tackifier in the polymer film is reached, at which point it reaches a plateau value. In this way it is possible to produce a calibration curve and to determine the maximum tackifier solubility in the polymer film. Measuring the different elasticity moduli of the different regions of a multiphase polymer film and comparing the results with the calibration curves produced beforehand, it is possible to determine the tackifier content in each individual region or each phase of the multiphase polymer film.

The example compositions B1-B6 were produced from the polymer dispersions A and B and different tackifiers. Parts by weight are based in each case on solids.

### Example B1

70 parts by weight polymer dispersion A

30 parts by weight tackifier (Dermulsene® DP 604)

### Example B2

70 parts by weight polymer dispersion B

30 parts by weight tackifier (Dermulsene® DP 604)

### Example B3

35 parts by weight polymer dispersion A

35 parts by weight polymer dispersion B

30 by weight tackifier (Dermulsene® DP 604)

### Example B4

35 parts by weight polymer dispersion A

35 parts by weight polymer dispersion B

30 parts by weight tackifier (Snowtack® 932)

### Example B5

35 parts by weight polymer dispersion A

35 parts by weight polymer dispersion B

30 parts by weight tackifier (Arizona® XR 4338)

### Example B6

35 parts by weight polymer dispersion A

35 parts by weight polymer dispersion B

30 parts by weight tackifier (Euro Yser®)

| | Elasticity modulus, | Elasticity modulus, |
|---|---|---|
| | Phase A | Phase B |
| Dispersion A | 27 MPa | — |
| Dispersion B | — | 23 MPa |
| Dispersion A + | 22 MPa | 22 MPa |
| Dispersion B (50/50) | | |
| B1 | 164 MPa | — |
| B2 | — | 107 MPa |
| B3 | 249 MPa | 80 MPa |
| B4 | 160 MPa | 103 MPa |
| B5 | 140 MPa | 94 MPa |
| B6 | 165 MPa | 93 MPa |

Addition of tackifier to the pure polymer dispersions leads to a marked increase in the elasticity modulus (B1 and B2). With all inventive examples B3-B6, multiphase films are formed that have two different polymer phases, with both phases taking up tackifier, but the tackifier being nonuniformly distributed in each case over the two polymer phases of the films. This becomes clear from the fact that the elasticity modulus of the polymer phase A of the polymer mixture (B3) is greater than the elasticity modulus of the pure polymer A (B1), whereas the elasticity modulus of the polymer phase B of the polymer mixture (B3) is smaller than the elasticity modulus of the pure polymer B (B2).

### Performance Tests

### a) Peel Strength (Adhesion)

The peel strength is the force with which an adhesive applied to a carrier material opposes removal from the substrate at a defined removal speed.

The adhesive under test is applied to the carrier material in the desired layer thickness, using a suitable laboratory coating table, and is dried in a forced-air drying cabinet at 90° C. for 3 minutes. Test strips 25 mm wide are cut from the coated carrier material in coating direction and are stored under standard conditions (23° C., 50% relative humidity) for at least 16 hours. One of the test strips is placed on the test substrate and rolled on using a roller weighing 1 kg. Testing takes place under standard conditions on a tensile testing machine. After the predetermined dwell time has elapsed, the test strip is removed from the test surface at 300 mm/min and at an angle of 180°, i.e., the test strip is bent around and removed parallel to the test substrate, and the application of force that is needed to achieve this is recorded. At least 3 individual measurements are made. The test results are reported in N/mm width.

The Investigations were Carried Out with the Following Parameters:
Carrier material: label paper 75 g/m²—unprimed
Test conditions: 23° C., 50% relative humidity
Width of test strip: 25 mm
Adhesive coatweight: 20 g/m²
Substrate: polyethylene

The results are listed in table 3.

### b) Shear Strength (Cohesion)

The shear strength is a measure of the cohesion. The adhesive under test is applied to the carrier material in the desired layer thickness (approximately 20 g/m²), using a suitable laboratory coating table, and is dried in a forced-air drying cabinet at 90° C. for 3 minutes. Test strips of 12.5 mm and of 2 cm in width are cut from the coated carrier material in coating direction, and are stored under standard conditions (23° C., 50% relative humidity) for at least 24 hours.

The test strips are adhered to the edge of a stainless steel test panel in such a way as to produce a bond area of 12.5 mm×12.5 mm. 20 minutes after bonding, a 500 g weight is attached to the protruding end of the test strip, and the metal test panel is suspended vertically. Ambient conditions: 23° C., 50% relative humidity. The shear strength reported is the time to failure of the bond under the influence of the weight, as an average value from the results for three test specimens, in hours.

The results are listed in table 3.

TABLE 3
Performance tests

| | Tackifier distribution | Peel strength | Shear |
|---|---|---|---|
| | in polymer phases | after 1 min | strength |
| | A and B | (N/25 mm) | [h] |
| B1 | | 17.4 | 4.6 |
| (Polymer A) | | | |
| B2 | | 13.8 | 10.6 |
| (Polymer B) | | | |
| B3 | Polymer phase A: 35 | 18.0 | 12.0 |
| (Polymer A + B) | Polymer phase B: 25 | | |

The results show that the adhesion values and cohesion values for inventive example B3, containing a polymer mixture and with a nonuniform distribution of tackifier, exceeds significantly the values for the comparative compositions B1 and B2, containing only one polymer and tackifier.

1. A polymer film with multiphase film morphology, where the film within a layer has regions of a first polymer and regions of at least one second polymer;
the film is prepared from an aqueous polymer dispersion comprising the first polymer in dispersed form, at least one second polymer in dispersed form, and at least one tackifier;
the glass transition temperature of the second polymer is greater than the glass transition temperature of the first polymer and is less than 20° C.; and
the concentration of the tackifier in the polymer film in the regions of the first polymer is greater than in the regions of the second polymer.

2. The polymer film according to claim 1, which comprises
the first polymer in an amount of 10 to 60 parts by weight,
the second polymer in an amount of 10 to 60 parts by weight, and
the tackifier in an amount of 10 to 40 parts by weight.

3. The polymer film according to either of the preceding claims, wherein the glass transition temperature of the first polymer is in the range from −60° C. to less than or equal to −10° C. and the glass transition temperature of the second polymer is in the range from −50° C. to less than or equal to 10° C., and
the glass transition temperature of the second polymer is at least 2° C. greater than the glass transition temperature of the first polymer.

4. The polymer film according to any of the preceding claims, wherein the weight fraction of the tackifier in the polymer film is at least 20% greater in the regions of the first polymer than the weight fraction of the tackifier in the regions of the second polymer.

5. The polymer film according to any of the preceding claims, wherein the tackifier is selected from the group consisting of natural-resin-based tackifiers, phenolic resins, coumarone-indene resins, polyterpene resins, terpene oligomers, and hydrocarbon resins based on unsaturated CH compounds.

6. The polymer film according to any of the preceding claims, wherein the first polymer and the second polymer are obtainable by free-radical polymerization of ethylenically unsaturated compounds and are composed to an extent of at least 60% by weight of principal monomers which are selected from C1 to C20 alkyl (meth)acrylates, vinyl esters of carboxylic acids comprising up to 20 C atoms, vinylaromatics having up to 20 C atoms, ethylenically unsaturated nitriles, vinyl halides, vinyl ethers of alcohols comprising 1 to 10 C atoms, aliphatic hydrocarbons having 2 to 8 C atoms and one or two double bonds, or mixtures of these monomers, the nature and amount of the monomers being adjusted such that the glass transition temperature of the second polymer is at least 2° C. greater than the glass transition temperature of the first polymer.

7. The polymer film according to the preceding claim, wherein the first polymer and the second polymer are each composed to an extent of at least 60% by weight of C₁ to C₁₀ alkyl (meth)acrylates.

8. The polymer film according to any of the preceding claims, wherein the first polymer and the second polymer are obtainable by free-radical polymerization of ethylenically unsaturated compounds and are composed of
(a) at least 60% by weight of at least one acrylate monomer selected from C1 to C10 alkyl acrylates which when polymerized as a homopolymer have a glass transition temperature of less than 0° C.,
(b) at least 0.1% by weight of at least one ethylenically unsaturated acid monomer, and
(c) optionally, further monomers different from monomers (a)-(b),
the nature and amount of the monomers being adjusted such that the glass transition temperature of the second polymer is at least 2° C. greater than the glass transition temperature of the first polymer.

9. The polymer film according to any of the preceding claims, wherein the second polymer has a higher degree of crosslinking than the first polymer, and/or the monomer mixture from which the second polymer is formed comprises a higher fraction of polyunsaturated crosslinking monomers than the monomer mixture from which the first polymer is formed.

10. The polymer film according to the preceding claim, wherein the crosslinking monomers are selected from divinylbenzene, alkanediol diacrylates, alkanediol dimethacrylates, allyl acrylates and allyl methacrylates.

11. The polymer film according to any of the preceding claims, which is a pressure-sensitive adhesive.

12. The polymer film according to any of the preceding claims, wherein the maximum solubility of the tackifier in the phase of the first polymer is at least 20% greater than the maximum solubility of the tackifier in the phase of the second polymer.

13. An aqueous polymer dispersion for forming a polymer film with multiphase film morphology according to claim 1, comprising a first polymer in dispersed form, at least one different, second polymer in dispersed form, and at least one tackifier dispersed or dissolved in the polymer dispersion, the glass transition temperature of the second polymer being greater than the glass transition temperature of the first polymer and being less than 20° C.; and the maximum solubility of the tackifier in the first polymer being greater than the maximum solubility of the tackifier in the second polymer.

14. A process for producing a polymer film with multiphase film morphology, wherein
(1) a first polymer and at least one second polymer are provided and the polymers, after filming of a mixture of the polymers, form a film having different regions within a layer, the glass transition temperature of the second polymer being greater than the glass transition temperature of the first polymer and being less than 20° C.;
(2) at least one tackifier is provided which is soluble both in the regions of the first polymer and in the regions of the second polymer; the maximum solubility of the tackifier in the regions of the first polymer is greater than the maximum solubility of the tackifier in the regions of the second polymer;
(3) from the first polymer, the second polymer, and the tackifier an aqueous dispersion is prepared;
(4) the dispersion is applied to a substrate; and
(5) a film is formed by evaporation of the water.

15. The process according to the preceding claim, which is a process of adhesively bonding two substrates, the first substrate, following the application of the aqueous dispersion, being contacted with a second substrate, and an adhesive bond being produced between the two substrates.

16. The use of a polymer film with multiphase film morphology according to any of claims 1 to 12 or of a polymer dispersion according to claim 13 as an adhesive, coating or sealant.

17. The use of a polymer film according to any of claims 1 to 12 or of a polymer dispersion according to claim 13 as a pressure-sensitive adhesive for producing self-adhesive paper labels, self-adhesive film labels or adhesive tapes.
